(19) United States
(12) Patent Application Publication
(10) Pub. No.: US 2016/0198647 A1
(43) Pub. Date: Jul. 14, 2016

(54) POWER SAVING CONTROL APPARATUS FOR REGULAR SPRINKLERS AND THE METHOD FOR OPERATING THE SAME

(71) Applicant: Cheng-Yu WANG, Lugu Township (TW)

(72) Inventor: Cheng-Yu WANG, Lugu Township (TW)

(21) Appl. No.: 14/593,225

(22) Filed: Jan. 9, 2015

(51) Int. Cl. A01G 25/16; H04W 4/00; G05B 15/02; B05B 12/00; B05B 12/12

(52) U.S. Cl. CPC A01G 25/167; B05B 12/004; B05B 12/12; G05B 15/02; H04W 4/008

(57) ABSTRACT

A power saving control apparatus for at least one regular sprinkler includes a wireless controller, at least one regular sprinkler and a first wireless communication module provided for bilaterally transmitting signals between the wireless controller and the at least one regular sprinkler for controlling the operating timing of the at least one regular sprinkler, wherein the first wireless communication module is a ZigBee module, the at least one regular sprinkler including a micro-control unit and a self tester disposed therein, when the self tester detecting an unusual operation in the at least one regular sprinkler, the self tester sends an unusual signal to the micro-control unit and wirelessly transmitted to the wireless controller by the first wireless communication module for informing the operator.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a control apparatus, and more particularly to a power saving control apparatus for regular sprinklers and the method for operating the same.

2. Description of Related Art Including Information Disclosed Under 37 CFR 1.97 and 37 CFR 1.98.

A tube for transporting liquid usually includes a control valve for controlling the transporting time or the flow. The conventional control valve is manual controlled such that there are many factors causing a usual operation, for example forgetting to operate the control valve in time. Consequently, a time switch is provided on the tube for automatically controlling the transporting time of the tube or the flow in the tube.

The conventional time switch can automatically operate the tube in preset time. For example, the time switch can be combined with a sprinkler to make the conventional sprinkler having a function of regular operation. For use in gardening, multiple sprinklers are necessary. It is hard to adjust the operation time of the sprinklers because the operator needs to adjust sprinklers one after one.

Consequently, a WiFi module is used as a medium for controlling multiple sprinklers at once. However, the WiFi module has some disadvantages that need to be advantageously altered. The WiFi module has a low security and a low wireless stability. In addition, the wirelessly controlling distance is limited. Furthermore, the WiFi module continually consumes power and the sprinkler cannot contain a great battery therein due to the structure thereof. As a result, the battery in the sprinkler needs to be often changed.

The present invention has arisen to mitigate and/or obviate the disadvantages of the conventional sprinklers.

### BRIEF SUMMARY OF THE INVENTION

The main objective of the present invention is to provide an improved power saving control apparatus for regular sprinklers and the method for operating the same.

To achieve the objective, the power saving control apparatus in accordance with the present invention comprises a wireless controller, at least one regular sprinkler and a first wireless communication module provided for bilaterally transmitting signals between the wireless controller and the at least one regular sprinkler for controlling the operating timing of the at least one regular sprinkler, wherein the first wireless communication module is a ZigBee module. The at least one regular sprinkler includes a micro-control unit and a self tester disposed therein. When the self tester detecting an unusual operation in the at least one regular sprinkler, the self tester sends an unusual signal to the micro-control unit and wirelessly transmitted to the wireless controller by the first wireless communication module for informing the operator.

The operating method the control apparatus in accordance with the present invention includes the steps of: encoding and installation: encoding the at least one regular sprinkler, the encoding data and the controlling parameters of the at least one regular sprinkler installed into a micro-control unit in the wireless controller by a first input module on the wireless controller; transmitting the controlling parameters: the wireless controller transmitting the controlling parameters to the at least one regular sprinkler by using a first wireless communication module for repeatedly operating the at least one regular sprinkler, wherein the first wireless communication module is a ZigBee module; and anomaly detecting: the at least one regular sprinkler does not detecting no water current when operating a sprinkling order or the at least one regular sprinkler detecting a water current when operating a closing order, the at least one regular sprinkler transmitting an unusual signal to the wireless controller by the first wireless communication module for warning the operator.

The control apparatus and the operating method in accordance with the present invention include the following advantages. First, the ZigBee module is power saving relative to the WiFi module because the WiFi module continually consume power. As a result, the use life of the power supply module in each of the regular sprinklers is lengthened. Second, the ZigBee module provided between the wireless controller and the regular sprinklers can be connected to more regular sprinklers than a WiFi module connected.

Further benefits and advantages of the present invention will become apparent after a careful reading of the detailed description with appropriate reference to the accompanying drawings.

### BRIEF DESCRIPTION OF THE SEVERAL VIEWS OF THE DRAWINGS

FIG. 1 is a schematic view of a control path of a power saving control apparatus for a regular sprinkler in accordance with the present invention.

FIG. 2 is a block diagram of a wireless controller of the control apparatus in FIG. 1.

FIG. 3 is a block diagram of a regular sprinkler of the control apparatus in FIG. 1.

FIG. 4 is a schematic view of a control path of a second embodiment of the power saving control apparatus in accordance with the present invention.

FIG. 5 is an exploded perspective view of the regular sprinkler in FIG. 1.

### DETAILED DESCRIPTION OF THE INVENTION

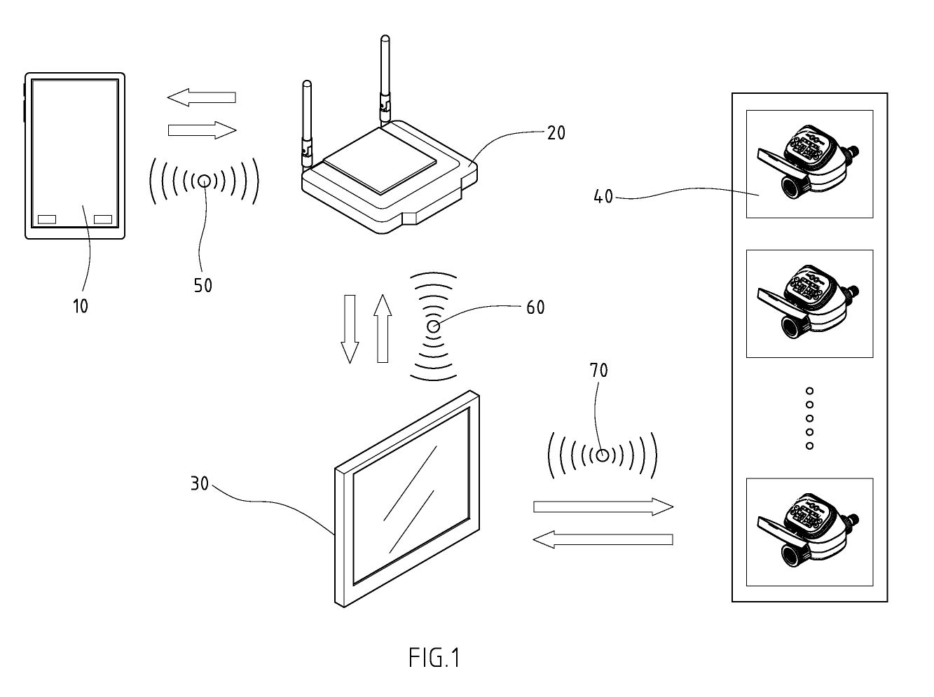

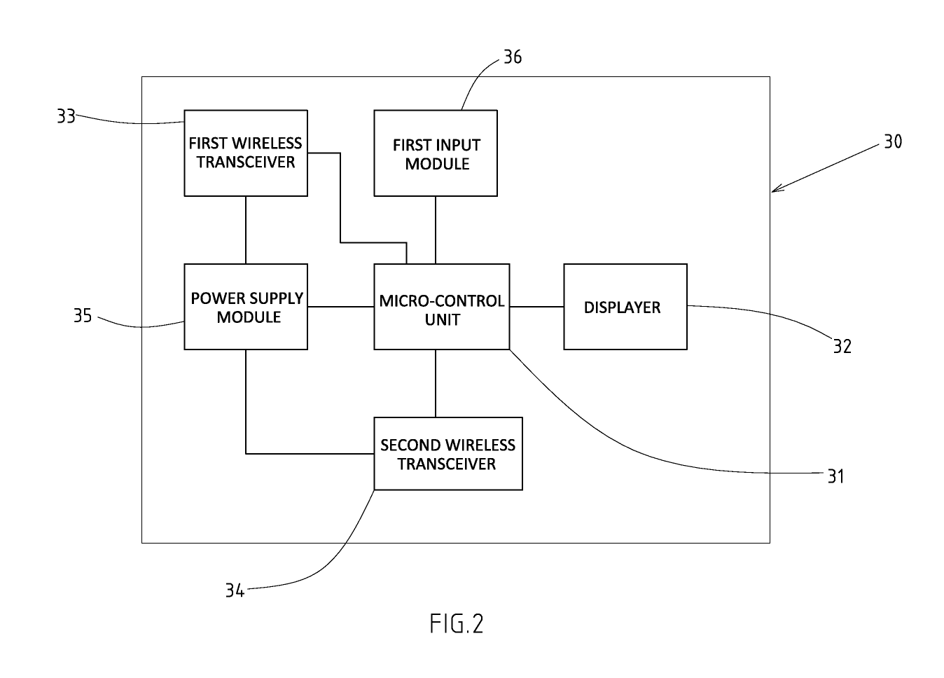

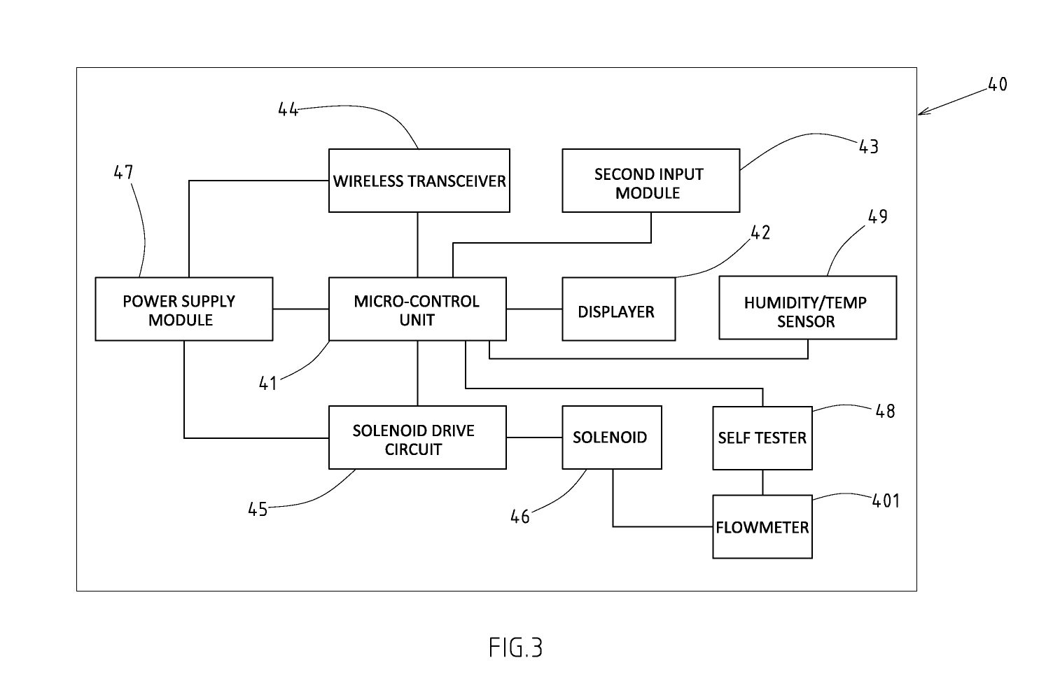

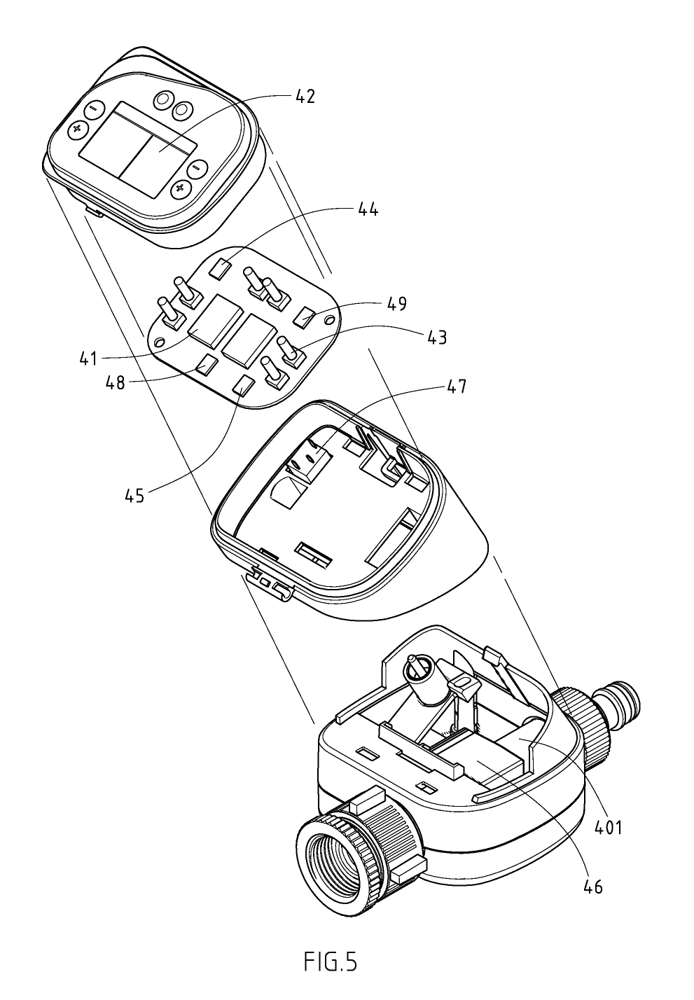

Referring to the drawings and initially to FIGS. 1-3 and 5, a power saving control apparatus for regular sprinklers in accordance with the present invention uses a wireless controller 30 to provide a wirelessly bilateral transmitting method for remotely controlling at least one regular sprinkler 40. In the preferred embodiment of the present invention, the wireless controller is provided to control multiple regular sprinklers 40. The power saving control apparatus comprises a wireless controller 30 for remotely controlling at least one regular sprinkler 40. In the preferred embodiment of the present invention, the wireless controller 30 remotely controls multiple regular sprinklers 40 at the same time, as shown in FIG. 1. A first wireless communication module 70 is disposed among the wireless controller 30 and the regular sprinklers 40 for bilaterally transmitting signals for synchronously controlling the regular sprinklers 40. For achieving the purpose of remotely control, the control apparatus in accordance with the present invention comprises a digital terminal 10 and a intranet router 20, wherein a second wireless communication module 60 is disposed between the intranet router 20 and the wireless controller 30 for bilaterally transmitting signals, and a third wireless communication module 50 is disposed between the intranet router 20 and the digital terminal 10 for bilaterally transmitting signals. In the preferred embodiment of the present invention, the first wireless communication module 70 is a ZigBee module, the second wireless communication module 60 is a WiFi module and the third wireless communication module 50 is a WiFi module. The digital terminal 10 is a smart phone, a computer or the like.

The wireless controller 30 includes a micro-control unit 31 disposed therein, a displayer 32 electrically connected to the micro-control unit 31, a first wireless transceiver 33 electrically connected to the micro-control unit 31, a second wireless transceiver 34 electrically connected to the micro-control unit 31 and a power supply module 35, wherein the power supply module 35 is electrically connected to the micro-control unit 31, the first wireless transceiver 33 and the second wireless transceiver 34 for providing power to the wireless controller 30 during being operated. A first input module 36 is disposed on the displayer 32 for operator to troubleshoot and set functions. The first wireless transceiver 33 transmits the signals, receiving from the regular sprinkler 40, to the micro-control unit 31 and transmits the signals, receiving from the micro-control unit 31, to the regular sprinkler 40. The second wireless transceiver 34 transmits signals, receiving from the intranet router 20, to the micro-control unit 31, and transmits signals, receiving from the micro-control unit 31, to the intranet router 20. The first wireless transceiver 33 is provided for transceiving ZigBee signals and the second wireless transceiver 34 is provided for transceiving WiFi signals.

Each regular sprinkler 40 includes a micro-control unit 41 disposed therein and a displayer 42 electrically connected to the micro-control unit 41 for displaying various operating order or adjusting messages. A second input module 43 is electrically connected to the micro-control unit 41 for correcting operating order, changing installation or troubleshooting. A wireless transceiver 44 is electrically connected to the micro-control unit 41. The wireless transceiver 44 transmits signals, receiving from the first wireless transceiver 33, to the micro-control unit 41 and transmits signals, receiving from the micro-control unit 41, to the first wireless transceiver 33, and the first wireless transceiver 33 transmits the signals, receiving from the wireless transceiver 44, to the micro-control unit 31. A solenoid drive circuit 45 is electrically connected to the micro-control unit 41 and a solenoid 46 is electrically connected to the solenoid drive circuit 45, wherein the solenoid 46 is adapted to be connected to an extra water source (not shown). The solenoid 46 opens the water path (not shown) in the regular sprinkler 40 for starting sprinkling when the micro-control unit 41 sends an operating signal to the solenoid 46 via the solenoid drive circuit 46. A power supply module 47 is respectively and electrically connected to the wireless transceiver 44, the micro-control unit 41 and the solenoid drive circuit 45 for providing the power when the regular sprinkler 40 is operated. The regular sprinkler 40 further includes a self tester 48, a humidity/temp sensor 49 and a flowmeter 401 respectively disposed therein, wherein the self tester 48 is electrically connected to the micro-control unit 41 and the solenoid 46, the humidity/temp sensor 49 is electrically connected to the micro-control unit 41, and the flowmeter 401 is respectively electrically connected to the self tester 48 and the solenoid 46.

The operating method of the power saving control apparatus for regular sprinklers in accordance with the present invention is described as follow. Firstly, each regular sprinkler 40 is encoded and the encoding information is installed into the micro-control unit 31 of the wireless controller 30 via the first input module 36. The operating details of each of the multiple regular sprinklers 40 are respectively to each regular sprinkler 40 by using the first wireless transceiver 33 via the first wireless communication module 70. After the wireless transceiver 44 of each of the regular sprinklers 40 receiving the operating details from the first wireless transceiver 33, the wireless transceiver 44 transmits the received operating details to the micro-control unit 41, immediately. Consequently, each regular sprinkler 40 automatically sprinkles water according to the received operating details.

In addition, the humidity/temp data from the humidity/temp sensor 49 of the regular sprinkler 40 is sequentially transmitted to the first wireless transceiver 33 and the wireless controller 30 by using the wireless transceiver 44 via the first wireless communication module 70 such that the operator can stochastically modify the operating order according to the received humidity/temp data. The regular sprinkler 40 automatically operates the solenoid 46 and sprinkles water when the regular sprinkler 40 receives no new operating order after transmitting the humidity/temp data for a period of time.

The flowmeter 401 of each of the regular sprinkler 40 operate the self tester 48 to delivery an unusual signal to the micro-control unit 41 of the regular sprinkler 40, the micro-control unit 41 operates the wireless transceiver 44 to send the unusual signal to the first wireless transceiver 33 via the first wireless communication module 70 and the micro-control unit 31 shows the unusual signal on the displayer 32 when the micro-control unit 41 sends a start order to the solenoid 46 and the flowmeter 401 in the unusual regular sprinkler 40 senses no water passing through. Consequently, the operator can immediately find the unusual regular sprinkler 40 and troubleshoot because every regular sprinkler 40 is previously encoded. The flowmeter 401 sends an unusual signal to the wireless controller 30 according to the transmitting mode, as described above, and the unusual signal is shown on the displayer 32 when the flowmeter 401 in the unusual regular sprinkler 40 continually senses the water current passing through a path in the unusual regular sprinkler 40 and the preset operating time is up.

According to the operating method as described above cannot provide a wide range of distance operation such that the operator must visit the site where the wireless controller 30 is disposed. For providing a convenient remotely operation, the second wireless communication module 60 is used for bilaterally transmitting signals between the intranet router 20 and the wireless controller 30. In addition, the third wireless communication module 50 is provided for bilaterally transmitting signals between the intranet router 20 and the digital terminal 10. In this operating mode, the wireless controller 30 is only used as a medium for bilaterally transmitting signals and all the operating order is sent from the digital terminal 10. The intranet router 20 and the wireless controller 30 are sequentially used for transmitting operating order to the regular sprinklers 40 via the third wireless communication module 50, the second wireless communication module 60 and the first wireless communication module 70 for wireless modifying the operating parameters of the regular sprinklers 40 and troubleshooting for the regular sprinklers 40.

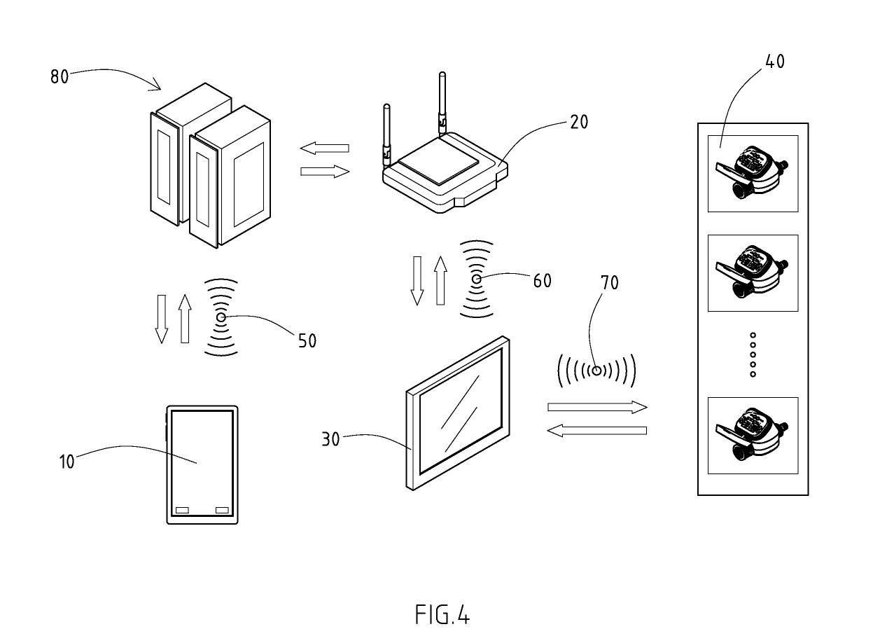

In the operating method as described above, the third wireless communication module 50 is disposed between the digital terminal 10 for bilaterally transmitting signals such that the wireless controlling distance is limited. However, the operator inevitably has a journey during operating the regular sprinklers 40 such that the digital terminal 10 cannot receive any signal from the intranet router. For solving the problem, with reference to FIG. 4, a cloud module 80 is provided between the intranet router 20 and the third wireless communication module 50. As a result, the operator can confirm the operating condition of each of the regular sprinklers 40 by internet anytime and anywhere. In this operating mode, the operator can inform his/her partner to check the unusual regular sprinkler 40 and troubleshooting by operating the wireless controller 30 when receiving an unusual signal form the unusual regular sprinkler 40. The troubleshooting processes are immediately transmitted to the digital terminal 10 by sequentially passing second wireless communication module 60, the intranet router 20, the cloud module 80 and the third wireless communication module 50 such that the operator can remotely confirm the operating condition of each of the regular sprinklers 40.

The first wireless communication module 70 between the wireless controller 30 and the regular sprinklers 40 is a ZigBee module including following properties:
First, the ZigBee technology has a high security. The ZigBee technology has never cracked until now.
Second, the ZigBee technology has a design for power saving. Theoretically, a power saving battery has ten year life when providing to the ZigBee technology. Indeed, a power saving battery van be used for two years when providing to the ZigBee technology.
Third, theoretically, a ZigBee gateway can connect to 65,000 equipments. The conventional WiFi signal and bluetooth signal cannot comparable relative to the ZigBee module.

As described above, the control apparatus and the operating method in accordance with the present invention include the following advantages.
First, the ZigBee module is power saving relative to the WiFi module because the WiFi module continually consume power. As a result, the use life of the power supply module 47 in each of the regular sprinklers 40 is lengthened.
Second, the ZigBee module provided between the wireless controller 30 and the regular sprinklers 40 can be connected to more regular sprinklers than a WiFi module connected.
Third, by using the self tester 48 in each of the regular sprinklers 40 and the cloud module 80, the operator can confirm the operating condition of each of the regular sprinklers 40 by internet anytime and anywhere.
Fourth, the humidity/temp sensor 49 can previously detect the temperature and the humidity of the operating environment of the regular sprinklers 40 for operator to modify the controlling data of each of the regular sprinklers 40 for effectively sprinkling water.

Although the invention has been explained in relation to its preferred embodiment, it is to be understood that many other possible modifications and variations can be made without departing from the spirit and scope of the invention as hereinafter claimed.

I claim:

1. A power saving control apparatus for at least one regular sprinkler, comprising a wireless controller, at least one regular sprinkler and a first wireless communication module provided for bilaterally transmitting signals between the wireless controller and the at least one regular sprinkler for controlling the operating timing of the at least one regular sprinkler, wherein the first wireless communication module is a ZigBee module, the at least one regular sprinkler including a micro-control unit and a self tester disposed therein, when the self tester detecting an unusual operation in the at least one regular sprinkler, the self tester sends an unusual signal to the micro-control unit and wirelessly transmitted to the wireless controller by the first wireless communication module for informing the operator.

2. The control apparatus as claimed in claim 1, wherein the wireless controller includes a micro-control unit disposed therein, a displayer electrically connected to the micro-control unit of the wireless controller, a first wireless transceiver electrically connected to the micro-control unit of the wireless controller and a power supply module, wherein the power supply module is electrically connected to the micro-control unit, the first wireless transceiver and the second wireless transceiver for providing power to the wireless controller during being operated, a first input module disposed on the displayer for operator to troubleshoot and set functions, wherein the first wireless transceiver transmits the signals, receiving from the regular sprinkler, to the micro-control unit and transmits the signals, receiving from the micro-control unit, to the regular sprinkler.

3. The control apparatus as claimed in claim 2, wherein the at least one regular sprinkler includes a wireless transceiver electrically connected to the micro-control unit of the at least one regular sprinkler, the wireless transceiver transmitting signals, receiving from the first wireless transceiver, to the micro-control unit and transmitting signals, receiving from the micro-control unit, to the first wireless transceiver, and the first wireless transceiver transmitting the signals, receiving from the wireless transceiver, to the micro-control unit of the wireless controller, a solenoid drive circuit electrically connected to the micro-control unit of the at least one regular sprinkler and a solenoid electrically connected to the solenoid drive circuit, wherein the solenoid is adapted to be connected to an extra water source and the solenoid opens the water path in the at least one regular sprinkler for starting sprinkling when the micro-control unit sends an operating signal to the solenoid via the solenoid drive circuit, the at least one regular sprinkler including a flowmeter electrically connected to the solenoid and the self tester, and a power supply module respectively and electrically connected to the wireless transceiver, the micro-control unit of the at least one regular sprinkler and the solenoid drive circuit for providing the power when the regular sprinkler is operated.

4. The control apparatus as claimed in claim 3, wherein the at least one regular sprinkler includes further includes a humidity/temp sensor disposed therein and electrically connected to the micro-control unit thereof for previously detecting the temperature and the humidity of the operating environment of the at least one regular sprinklers for operator to modify the controlling data of the at least one regular sprinklers for effectively sprinkling water.

5. The control apparatus as claimed in claim 3, further comprising a intranet router and a digital terminal, and wherein the wireless controller further includes a second wireless transceiver electrically connected to the power supply module and the micro-control unit thereof, a second wireless communication module disposed between the intranet router and the second wireless transceiver for bilaterally transmitting signals, a third wireless communication module provided between the intranet router and the digital terminal for bilaterally transmitting signals, wherein the second wireless communication module is a WiFi module.

6. The control apparatus as claimed in claim 4, further comprising a intranet router and a digital terminal, and wherein the wireless controller further includes a second wireless transceiver electrically connected to the power supply module and the micro-control unit thereof, a second wireless communication module disposed between the intranet router and the second wireless transceiver for bilaterally transmitting signals, a third wireless communication module provided between the intranet router and the digital terminal for bilaterally transmitting signals, wherein the second wireless communication module is a WiFi module.

7. The control apparatus as claimed in claim 5, further comprising a cloud module disposed between the third wireless communication module and the intranet router for widening the remote controlling distance of the digital terminal.

8. The control apparatus as claimed in claim 6, further comprising a cloud module disposed between the third wireless communication module and the intranet router for widening the remote controlling distance of the digital terminal.

9. The control apparatus as claimed in claim 3, wherein the at least one regular sprinkler further includes a displayer electrically connected to the micro-control unit of the at least one regular sprinkler for displaying various operating order or adjusting messages, and a second input module electrically connected to the micro-control unit of the at least one regular sprinkler for correcting operating order, changing installation or troubleshooting.

10. The control apparatus as claimed in claim 4, wherein the at least one regular sprinkler further includes a displayer electrically connected to the micro-control unit of the at least one regular sprinkler for displaying various operating order or adjusting messages, and a second input module electrically connected to the micro-control unit of the at least one regular sprinkler for correcting operating order, changing installation or troubleshooting.

11. An operating method of a power saving control apparatus for at least one regular sprinkler, which includes a wireless controller, at least one regular sprinkler and a first wireless communication module provided for bilaterally transmitting signals between the wireless controller and the at least one regular sprinkler for controlling the operating timing of the at least one regular sprinkler, the operating method comprising the steps of:
encoding and installation: encoding the at least one regular sprinkler, the encoding data and the controlling parameters of the at least one regular sprinkler installed into a micro-control unit in the wireless controller by a first input module on the wireless controller;
transmitting the controlling parameters: the wireless controller transmitting the controlling parameters to the at least one regular sprinkler by using a first wireless communication module for repeatedly operating the at least one regular sprinkler, wherein the first wireless communication module is a ZigBee module; and
anomaly detecting: the at least one regular sprinkler does not detecting no water current when operating a sprinkling order or the at least one regular sprinkler detecting a water current when operating a closing order, the at least one regular sprinkler transmitting an unusual signal to the wireless controller by the first wireless communication module for warning the operator.

12. The operating method as claimed in claim 11, further using an intranet router and a digital terminal for achieving the purpose of remote operation, wherein a second wireless communication module is provided between the intranet router and the wireless controller for bilaterally transmitting signals, a third wireless communication module is provided between the intranet router and the digital terminal for bilaterally transmitting signals, and the second wireless communication module is a WiFi module.

13. The operating method as claimed in claim 12, wherein a cloud module is provided between the third wireless communication module and the intranet router for lengthening the remote control distance.

14. The operating method as claimed in claim 11, further comprising a step of detecting humidity and temperature, wherein the at least one regular sprinkler includes a humidity/temp sensor disposed therein, the humidity/temp data from the humidity/temp sensor of the at least one regular sprinkler sequentially transmitted to the wireless controller by using the first wireless communication module such that the operator can stochastically modify the operating order according to the received humidity/temp data.

15. The operating method as claimed in claim 12, further comprising a step of detecting humidity and temperature, wherein the at least one regular sprinkler includes a humidity/temp sensor disposed therein, the humidity/temp data from the humidity/temp sensor of the at least one regular sprinkler sequentially transmitted to the wireless controller by using the first wireless communication module such that the operator can stochastically modify the operating order according to the received humidity/temp data.

16. The operating method as claimed in claim 13, further comprising a step of detecting humidity and temperature, wherein the at least one regular sprinkler includes a humidity/temp sensor disposed therein, the humidity/temp data from the humidity/temp sensor of the at least one regular sprinkler sequentially transmitted to the wireless controller by using the first wireless communication module such that the operator can stochastically modify the operating order according to the received humidity/temp data.
